(19) United States
(12) Patent Application Publication
(10) Pub. No.: US 2002/0193486 A1
(43) Pub. Date: Dec. 19, 2002

(54) Chlorinated polyolefin resin composition

(76) Inventors: Terutoshi Kumaki, Kawasaki-shi (JP); Hikaru Aoyagi, Yokohama-shi (JP); Tsutomu Arakawa, Tokyo (JP)

Correspondence Address: SUGHRUE MION, PLLC, 2100 PENNSYLVANIA AVENUE, N.W., WASHINGTON, DC, 20037, US

(21) Appl. No.: 10/110,947

(22) PCT Filed: Aug. 17, 2001
(86) PCT No.: PCT/JP01/07082

(30) Foreign Application Priority Data
Aug. 21, 2000 (JP) 2000-249979

(51) Int. Cl. C08K 3/10; C08K 3/26

(52) U.S. Cl. 524/409; 524/425

(57) ABSTRACT

A flexible flame-retardant chlorinated polyolefin resin composition contains no plasticizer, generates almost no halogen-containing gas and no significant amounts of smoke during combustion. Uses thereof are also given. The chlorinated polyolefin resin composition comprises 50-95 parts of a chlorinated polyolefin, 50-5 parts of a copolymer of ethylene/a compound having ethylenic unsaturated groups/carbon monoxide (the total amount of this copolymer and the chlorinated polyolefin being 100 parts), 10-100 parts of a metal hydroxide, and 10-100 parts of calcium carbonate (“parts” herein indicates parts by weight); a formed article formed by shaping this chlorinated polyolefin resin composition; and a process for imparting flame retardancy using this chlorinated polyolefin resin composition.

### TECHNICAL FIELD

The present invention relates to flexible flame-retardant chlorinated polyolefin resin compositions which, during combustion, generate almost no halogen-containing gases such as hydrogen chloride, and do not generate significant amounts of smoke.

### BACKGROUND ART

As resin compositions which are flexible and exhibit good oil resistance, resin compositions containing polyvinyl chloride as a main component are known. In such a resin composition, a plasticizer is normally used to impart flexibility. However, in order to avoid emission of even extremely small amounts of volatile components, a flexible resin composition which does not contain organic low molecular weight components, such as a plasticizer, has recently been sought. In addition, although a halogen-containing resin is itself flame retardant and may be advantageously used to impart flame retardancy, it nevertheless generates halogen-containing gas, such as hydrogen chloride gas, and a relatively large amount of smoke during combustion; therefore, a halogen-containing resin which emits less gas and smoke during combustion is desired.

### DISCLOSURE OF INVENTION

The present invention was conceived in view of the above situation. An object of the present invention is to provide a flexible flame-retardant chlorinated polyolefin resin composition which contains no plasticizer (which may be a source of very small amounts of volatile components) and which generates almost no halogen-containing gas and no significant amounts of smoke during combustion, so as to solve the above problems in the background art simultaneously.

The present inventors have diligently carried out research in developing flexible flame-retardant chlorinated polyolefin resin compositions which generate almost no halogen-containing gas and no significant amounts of smoke, and as a result they have found that a chlorinated polyolefin resin composition which comprises a resin (which contains a chlorinated polyolefin and a copolymer of ethylene/a compound having ethylenic unsaturated groups/carbon monoxide), a metal hydroxide, and calcium carbonate in combination can achieve the above object. Based on this finding, the present invention was accomplished.

That is, the present invention relates to a chlorinated polyolefin resin composition as in the following (1) to (12):

(1) A chlorinated polyolefin resin composition comprising:

a chlorinated polyolefin in an amount of 50 to 95 parts by weight,

a copolymer of ethylene/a compound having ethylenic unsaturated groups/carbon monoxide in an amount of 50 to 5 parts by weight (the total amount of this copolymer and the chlorinated polyolefin being 100 parts by weight),

a metal hydroxide in an amount of 10 to 100 parts by weight, and

calcium carbonate in an amount of 10 to 100 parts by weight.

(2) A chlorinated polyolefin resin composition according to (1), comprising antimony trioxide in an amount of 2 to 50 parts by weight.

(3) A chlorinated polyolefin resin composition according to (1) or (2), wherein the chlorinated polyolefin is at least one of a chlorinated polyethylene and a chlorinated ethylene-propylene copolymer.

(4) A chlorinated polyolefin resin composition according to any one of (1) to (3), wherein the copolymer of ethylene/a compound having ethylenic unsaturated groups/carbon monoxide is a copolymer of ethylene/an acrylic ester/carbon monoxide.

(5) A chlorinated polyolefin resin composition according to any one of (1) to (4), wherein the metal hydroxide is aluminum hydroxide.

(6) A chlorinated polyolefin resin composition according to any one of (1) to (5), wherein an average particle diameter of the metal hydroxide is 2 μm or less.

(7) A chlorinated polyolefin resin composition according to any one of (1) to (6), wherein an average particle diameter of the calcium carbonate is 2 μm or less.

(8) A formed article formed by shaping the chlorinated polyolefin resin composition according to any one of (1) to (7).

(9) An electrical component comprising the formed article according to (8).

(10) An electrical component according to (9), which is a coated wire.

(11) A process for imparting flame retardancy comprising adding to a halogen-containing resin a chlorinated polyolefin resin composition containing:

a chlorinated polyolefin in an amount of 50 to 95 parts by weight,

a copolymer of ethylene/a compound having ethylenic unsaturated groups/carbon monoxide in an amount of 50 to 5 parts by weight (the total amount of this copolymer and the chlorinated polyolefin being 100 parts by weight),

a metal hydroxide in an amount of 10 to 100 parts by weight, and

calcium carbonate in an amount of 10 to 100 parts by weight.

(12) A process for imparting flame retardancy comprising adding to a halogen-containing resin a chlorinated polyolefin resin composition containing:

a chlorinated polyolefin in an amount of 50 to 95 parts by weight,

a copolymer of ethylene/a compound having ethylenic unsaturated groups/carbon monoxide in an amount of 50 to 5 parts by weight (the total amount of this copolymer and the chlorinated polyolefin being 100 parts by weight),

a metal hydroxide in an amount of 10 to 100 parts by weight,

calcium carbonate in an amount of 10 to 100 parts by weight, and

antimony trioxide in an amount of 2 to 50 parts by weight.

### BEST MODE FOR CARRYING OUT THE INVENTION

The present invention will be explained in detail in the following.

A chlorinated polyolefin which can be used in the present invention can be obtained by chlorinating a polyolefin, which is a raw material. Specific examples of the polyolefin are crystalline polymers such as a homopolymer of ethylene, propylene, 1-butene, 1-pentene, 1-hexene, 4-methyl-1-pentene, and the like, a copolymer of ethylene and an α-olefin, and a copolymer of two or more types of α-olefins. One type of these polyolefins alone, or two or more types of these polyolefins in combination, can be employed.

Examples of the α-olefin which can be used in the copolymer are 1-butene, 1-hexene, 1-octene, and 4-methyl-1-pentene.

Among these polyolefins, a polyethylene and an ethylene-propylene copolymer are preferable. That is, as the chlorinated polyolefin, a chlorinated polyethylene and a chlorinated ethylene-propylene copolymer are preferable.

Any known chlorinating method, such as the aqueous suspension method, the solution method, and the gas phase method, can be employed for chlorinating the above polyolefin. The chlorination is carried out, preferably by the aqueous suspension method, among the above methods. There are detailed disclosures, for example, in Japanese Unexamined Patent Applications, First Publication Nos. Sho 54-124096, Hei 4-106109, and Hei 5-195502.

The structure of the chlorinated polyolefin of the present invention is not particularly limited. However, the chlorine content in the chlorinated polyolefin is preferably 20 to 50%, and more preferably 30 to 45%. In addition, the amount of crystal remaining in the chlorinated polyolefin according to the DSC method is preferably 10 to 70 J/g, and particularly preferably 15 to 50 J/g, in view of balance between heat resistance and flexibility.

Here, the “DSC method” refers to the differential scanning calorimetry method, in which thermal transition which takes place when the temperature of a specimen is increased or decreased at a constant rate is quantified as an amount of heat energy. The amount of crystal remaining can be obtained from the heat of fusion of the crystal which is calculated from the area of crystalline peak according to the DSC method.

An example of the copolymer of ethylene/a compound having ethylenic unsaturated groups/carbon monoxide which is used in the present invention is a tri-component copolymer composed of ethylene, a compound having ethylenic unsaturated groups, and carbon monoxide (hereinafter referred to as “tri-component copolymer”) . A copolymer which incorporates, in addition to those monomers capable of forming the tri-component copolymer, a monomer which is copolymerizable with these monomers may also be used as the tri-component copolymer for the present invention.

Examples of the compounds having ethylenic unsaturated groups are a C₃ to C₂₀ unsaturated monocarboxylic or dicarboxylic acid and an ester compound thereof, a C₂ to C₁₈ vinyl alkyl ether having an acid group, a vinyl halide, vinylidene acrylonitrile, (meth)acrylonitrile, norbornene, a C₃ to C₁₂ α-olefin, and a vinyl aromatic compound.

Examples of the C₃ to C₂₀ unsaturated monocarboxylic or dicarboxylic acids and the ester compounds thereof are: an unsaturated monocarboxylic acid such as acrylic acid, methacrylic acid (hereinafter “(meth)acrylic acid” includes both acrylic acid and methacrylic acid), and crotonic acid; an unsaturated dicarboxylic acid such as maleic acid, fumaric acid, itaconic acid, citraconic acid, and endobicyclo-[2,2,1]-hept-5-ene-2,3-dicarboxylic acid; an unsaturated monocarboxylic acid ester such as methyl (meth)acrylate, ethyl (meth)acrylate, butyl (meth)acrylate, pentyl (meth)acrylate, hexyl (meth)acrylate, heptyl (meth)acrylate, n-octyl (meth)acrylate, 2-ethylhexyl (meth)acrylate, isononyl (meth)acrylate, decyl (meth)acrylate, dodecyl (meth)acrylate, benzyl (meth)acrylate, and cyclohexyl (meth)acrylate; and unsaturated dicarboxylic acid ester such as dimethyl maleate, diethyl maleate, dibutyl maleate, dimethyl fumarate, diethyl fumarate, and dibutyl fumarate.

Examples of the vinyl halide are vinyl chloride, vinylidene chloride, and a chlorosulfonated vinyl.

Examples of the C₃ to C₁₂ α-olefins are propylene, 1-butene, 1-pentene, 3-methyl-1-butene, 1-hexene, 4-methyl-1-pentene, 1-octene, 1-decene, and 1-dodecene.

Examples of the vinyl aromatic compounds are styrene, α-methylstyrene, chlorostyrene, styrenesulfonic acid, 4-hydroxystyrene, and vinyltoluene.

Among the above compounds having ethylenic unsaturated groups, the unsaturated monocarboxylic acid ester is preferable, and a (meth)acrylic acid alkyl ester is more preferable, such as methyl (meth)acrylate, ethyl (meth)acrylate, butyl (meth)acrylate, pentyl (meth)acrylate, hexyl (meth)acrylate, heptyl (meth)acrylate, n-octyl (meth)acrylate, 2-ethylhexyl (meth)acrylate, isononyl (meth)acrylate, decyl (meth)acrylate, and dodecyl (meth)acrylate.

The proportion of the compound having ethylenic unsaturated groups in the copolymer is preferably 4 to 60% by weight, and more preferably 20 to 40% weight.

The proportion of carbon monoxide in the copolymer is preferably 4 to 15% by weight.

The tri-component copolymer can be obtained using equipment and a method which are employed for the production of low-density polyethylenes. Alternatively, a commercially available tri-component copolymer may also be used.

The mixing ratio of the chlorinated polyolefin to the tri-component copolymer according to the present invention is 50/50 to 95/5 by weight. A mixing proportion of the chlorinated polyolefin of greater than 95 by weight is not preferable since sufficient flexibility cannot be obtained. A mixing proportion of the chlorinated polyolefin of less than 50 by weight is not preferable since flame retardancy, heat resistance, and the like are degraded.

As the metal hydroxide for the present invention, ones generally known as inorganic flame retarding agents such as aluminum hydroxide, magnesium hydroxide, zirconium hydroxide, and the like may be used. The metal hydroxide may be a hydrate. A single metal hydroxide or a combination of two or more metal hydroxides may be used. Among these metal hydroxides, aluminum hydroxide and magnesium hydroxide are preferable, and aluminum hydroxide, which is highly effective in suppressing generation of halogen-containing gas, is particularly preferable.

Properties of the metal hydroxide are not particularly limited; however, a metal hydroxide having an average particle diameter of 2 μm or less is preferable since such a metal hydroxide is well dispersible into the resin composition and has a large surface area, and therefore is highly effective in flame retardancy. A metal hydroxide which has undergone surface treatment of a fatty acid or its salt may also be used.

The mixing proportion of the metal hydroxide is 10 to 100 parts by weight, and is preferably 20 to 70 parts by weight, with respect to 100 parts by weight of the resin contents composed of the chlorinated polyolefin and the tri-component copolymer. A mixing proportion of the metal hydroxide of less than 10 parts by weight is not preferable since a sufficient flame retarding effect cannot be obtained. A mixing proportion of the metal hydroxide of greater than 100 parts by weight is not preferable since mechanical strength, such as impact strength, and flexibility are degraded.

The calcium carbonate used for the present invention may be a calcium carbonate heavy or a colloidal calcium carbonate. However, calcium carbonate having an average diameter of 2 μm is preferable since such calcium carbonate is well dispersible into the resin composition and has a large surface area, and therefore is highly effective in capturing hydrogen chloride. Calcium carbonate which has undergone surface treatment of a fatty acid or its salt may also be used.

The mixing proportion of the calcium carbonate is 10 to 100 parts by weight, and is preferably 20 to 70 parts by weight, with respect to 100 parts by weight of the resin contents composed of the chlorinated polyolefin and the tri-component copolymer. A mixing proportion of the calcium carbonate of less than 10 parts by weight is not preferable since a sufficient effect in capturing hydrogen chloride gas cannot be obtained. A mixing proportion of the calcium carbonate of greater than 100 parts by weight is not preferable since mechanical strength, such as impact strength, and flexibility are degraded.

If the need arises, the following processing aids or the like may be added to the composition of the present invention depending on the application of the composition in an amount which does not substantially impair the properties of the composition of the present invention: a stabilizer for a polyvinyl chloride such as a tin-based stabilizer, a lead-based stabilizer, a calcium—zinc-based stabilizer, an epoxy compound, and the like; a phosphorous flame retardant; a flame retardant auxiliary; an ultraviolet absorber; an antioxidant; a pigment; a colorant; a lubricant; and the like.

Specific examples of the tin-based stabilizers are: di-n-octyltin-based stabilizers such as a di-n-octyltin bis(iso-octylthioglycolic acid ester) salt, a di-n-octyltin maleic acid salt polymer, di-n-octyltin dilaurate, a di-n-octyltin lauric acid salt, and a di-n-octyltin bismaleic acid ester salt; di-n-butyltin-based stabilizers such as a di-n-butyltin bismaleic acid ester salt, a di-n-butyltin maleic acid salt polymer, a di-n-butyltin bisoctylthioglycol ester salt, a di-n-butyltin-β-mercaptopropionic acid salt polymer, and a di-n-butyltin dilaurate; and a di-n-methyltin bis(isooctyl mercaptoacetate) salt.

Examples of the lead-based stabilizers are tribasic lead sulfate, dibasic lead phosphite, basic lead sulfite, dibasic lead phthalate, lead silicate, dibasic lead stearate, and lead stearate.

Examples of the phosphorous flame retardants are: phosphoric acid esters such as dimelamine pyrophosphate and melamine phosphate; polyphosphoric acid esters such as polyammonium phosphate, polymelamine phosphate, polymelam phosphate, and polymelon phosphate; and red phosphorus.

Examples of the flame retardant auxiliaries are: borate compounds such as zinc borate, lead borate, and barium metaborate; antimony compounds such as antimony trioxide, antimony pentoxide; molybdenum compounds; and metal oxides such as copper (II) oxide, iron (III) oxide, and zirconium oxide. Among these, antimony trioxide is preferable since it cooperates with chlorine to exert a superior flame retarding function, and is highly effective in suppressing generation of halogen-containing gas. The amount of the flame retardant auxiliary to be used is preferably 2 to 50 parts by weight, and more preferably 3 to 30 parts by weight, with respect to 100 parts by weight of the resin contents composed of the chlorinated polyolefin and the tri-component copolymer.

Examples of the ultraviolet absorbers are p-t-butylphenyl salicylate, 2-hydroxy-4-methoxybenzophenone, 2-hydroxy-4-octoxybenzophenone, 2,2′-dihydroxy-4-methoxybenzophenone, 2-(2′-hydroxy-5′-methylphenyl)benzotriazole, 2-(2′-hydroxy-3′-t-butyl-5′-methylphenyl)-5-chlorobenzotriazole, and 2-(2′-hydroxy-3,5′-di-t-butylphenyl)benzotriazole.

Examples of the lubricants are stearic acid, calcium stearate, and magnesium stearate.

The chlorinated polyolefin resin composition of the present invention can be obtained by kneading the ingredients by a method which is conventional in this technical field, using, for example, a mixing roll, a Banbury mixer, a kneader, or an extruder.

By melt molding the chlorinated polyolefin resin composition of the present invention into a desired shape by extrusion molding or compression molding, a flexible flame-retardant formed article which generates almost no halogen-containing gases such as hydrogen chloride during combustion can be obtained.

In addition, the flame-retardant formed article obtained by molding the chlorinated polyolefin resin composition of the present invention is suitable for electrical components for which extremely low generation of halogen-containing gas, such as hydrogen chloride gas, and flame retardancy are required.

Furthermore, a coated wire obtained by using a formed chlorinated polyolefin resin composition of the present invention is flexible and highly heat resistant, and generates almost no halogen-containing gas, such as hydrogen chloride, during combustion. Therefore, such a coated wire is very useful as a coated wire used for interior wiring or the like of machines for transportation (such as automobiles), industrial machines, or electric or electronic devices.

A process for imparting flame retardancy by adding the chlorinated polyolefin resin composition of the present invention to another halogen-containing resin can be suitably employed as a useful process of imparting flame retardancy since the amount of halogen-containing gas generated, such as hydrogen chloride gas, from the resin composition to which the chlorinated polyolefin resin composition of the present invention is added, can be reduced, the mechanical strength is improved, and the heat resistance is superior.

Examples of the halogen-containing resins are homopolymers of vinyl chloride, vinylidene chloride, and chlorosulfonated vinyl, and copolymers of these with other monomers copolymerizable with these such as: carboxylic acids such as acrylic acid, methacrylic acid, and maleic anhydride, and their esters; vinyl esters such as vinyl acetate and vinyl stearate; ethylene; and acrylonitrile.

In addition, in the above process, use of antimony trioxide as a flame retardant auxiliary in the chlorinated polyolefin resin composition is effective in imparting an even higher degree of flame retardancy.

### EXAMPLES

The present invention will be described in more detail by examples in the following. However, the present invention is not limited to these examples.

As the chlorinated polyolefins, a chlorinated polyethylene having a chlorine content of 40% and an amount of remaining crystal of 24 J/g (hereinafter referred to as “CPO1”) and a chlorinated polyethylene having a chlorine content of 30% and an amount of remaining crystal of 40 J/g (hereinafter referred to as “CPO2”) were used.

As the tri-component copolymer, a copolymer of ethylene/methyl acrylate/carbon monoxide (“ELVALOY” manufactured by Mitsui-DuPont Polychemicals Co., Ltd., having a melt index of 25 g/10 minutes, a melting point of 55° C., and a glass transition temperature of −42° C.) was used.

As the aluminum hydroxide, “HIGILITE H-42S” (manufactured by Showa Denko K. K.) was used.

As the calcium carbonate, “HAKUENKA CC” (manufactured by Shiraishi Calcium Co., Ltd.) was used.

A composition containing the components in specific mixing proportions as in Table 1 was kneaded using an open-roll mill at 130° C. to form a sheet. Compression molding of this sheet was carried out at a molding temperature of 170° C. to prepare sheets having thicknesses of 2 mm and 3 mm. The mechanical properties, the heat deformation ratio, the oxygen index, and the amount of hydrogen chloride generated were measured for these sheets.

The methods for testing the physical properties are described in the following.

### Flexibility

The mechanical properties of a sheet having a thickness of 2 mm were measured in accordance with Japanese Industrial Standard (JIS) K-6251. The 100% modulus was used as the index. The symbol \mathring{∘} indicates a 100% modulus of 2 MPa or less, the symbol ◯ indicates a 100% modulus of 2 to 3 MPa (exclusive), and X indicates a 100% modulus of 3 MPa or more.

The heat deformation ratio of a sheet having a thickness of 2 mm was measured in accordance with Japanese Industrial Standard (JIS) K-6723. The symbol \mathring{∘} indicates a heat deformation ratio of 25% or less, the symbol ◯ indicates a heat deformation ratio of 25% to 50% (exclusive), and X indicates a heat deformation ratio of 50% or more.

### Flame Retardancy

The oxygen index of a sheet having a thickness of 3 mm was measured in accordance with Japanese Industrial Standard (JIS) K-7201. The symbol \mathring{∘} indicates an oxygen index of 30 or more, the symbol ◯ indicates an oxygen index of 28 to 30 (exclusive), and X indicates an oxygen index of 28 or less.

### Amount of Halogen-Containing Gas Generated

The amount of halogen-containing gas generated was measured in accordance with Japanese Industrial Standard (JIS) K-7217 using a sheet having a thickness of 3 mm. The symbol \mathring{∘} indicates the amount of halogen-containing gas generated was 50 mg/g or less, the symbol ◯ indicates the amount of halogen-containing gas generated was 50 to 100 mg/g (exclusive), and X indicates the amount of halogen-containing gas generated was 100 mg/g or more.

The results of the above tests for properties of the sheets are shown in Table 1.

TABLE 1

| | Example | | | Comparative Example | | | | |
|---|---|---|---|---|---|---|---|---|
| | 1 | 2 | 3 | 1 | 2 | 3 | 4 | 5 |
| CPO1 | 80 | 40 | 60 | 100 | 40 | 80 | 80 | 80 |
| CPO2 | | 40 | | | | | | |
| HP551 | 20 | 20 | 40 | | 60 | 20 | 20 | 20 |
| H-42S | 50 | 50 | 30 | 50 | 30 | 5 | 30 | 30 |
| HAKUENKA CC | 30 | 30 | 30 | 30 | 30 | 30 | 5 | 150 |
| Flexibility | ⊚ | ◯ | ⊚ | X | ⊚ | ⊚ | ⊚ | X |
| Heat resistance | ⊚ | ⊚ | ◯ | ⊚ | X | ◯ | ◯ | ⊚ |
| Flame retardancy | ⊚ | ⊚ | ◯ | ⊚ | X | X | ⊚ | ◯ |
| Amount of halogen- | ◯ | ⊚ | ⊚ | ◯ | ⊚ | ◯ | X | ⊚ |
| containing gas | | | | | | | | |
| generated | | | | | | | | |

*5 parts by weight of antimony trioxide are added to each composition of Examples and Comparative Examples.

### INDUSTRIAL APPLICABILITY

The chlorinated polyolefin resin composition according to the present invention contains no plasticizer, which may be a source of very small amounts of volatile components, generates almost no halogen-containing gas and no significant amounts of smoke during combustion, has excellent flexibility, and has good flame retardancy. Accordingly, the composition can be used in, and is useful in, the electric and electronic fields.

1. A chlorinated polyolefin resin composition comprising:
a chlorinated polyolefin in an amount of 50 to 95 parts by weight,
a copolymer of ethylene/a compound having ethylenic unsaturated groups/carbon monoxide in an amount of 50 to 5 parts by weight (the total amount of this copolymer and the chlorinated polyolefin being 100 parts by weight),
a metal hydroxide in an amount of 10 to 100 parts by weight, and
calcium carbonate in an amount of 10 to 100 parts by weight.

2. A chlorinated polyolefin resin composition according to claim 1, comprising antimony trioxide in an amount of 2 to 50 parts by weight.

3. A chlorinated polyolefin resin composition according to claim 1, wherein the chlorinated polyolefin is at least one of a chlorinated polyethylene and a chlorinated ethylene-propylene copolymer.

4. A chlorinated polyolefin resin composition according to claim 1, wherein the copolymer of ethylene/a compound having ethylenic unsaturated groups/carbon monoxide is a copolymer of ethylene/an acrylic ester/carbon monoxide.

5. A chlorinated polyolefin resin composition according to claim 1, wherein the metal hydroxide is aluminum hydroxide.

6. A chlorinated polyolefin resin composition according to claim 1, wherein an average particle diameter of the metal hydroxide is 2 μm or less.

7. A chlorinated polyolefin resin composition according to claim 1, wherein an average particle diameter of the calcium carbonate is 2 μm or less.

8. A formed article formed by shaping the chlorinated polyolefin resin composition according to claim 1.

9. An electrical component comprising the formed article according to claim 8.

10. An electrical component according to claim 9, which is a coated wire.

11. A process for imparting flame retardancy comprising adding to a halogen-containing resin a chlorinated polyolefin resin composition containing:
a chlorinated polyolefin in an amount of 50 to 95 parts by weight,
a copolymer of ethylene/a compound having ethylenic unsaturated groups/carbon monoxide in an amount of 50 to 5 parts by weight (the total amount of this copolymer and the chlorinated polyolefin being 100 parts by weight),
a metal hydroxide in an amount of 10 to 100 parts by weight, and
calcium carbonate in an amount of 10 to 100 parts by weight.

12. A process for imparting flame retardancy comprising adding to a halogen-containing resin a chlorinated polyolefin resin composition containing:
a chlorinated polyolefin in an amount of 50 to 95 parts by weight,
a copolymer of ethylene/a compound having ethylenic unsaturated groups/carbon monoxide in an amount of 50 to 5 parts by weight (the total amount of this copolymer and the chlorinated polyolefin being 100 parts by weight),
a metal hydroxide in an amount of 10 to 100 parts by weight,
calcium carbonate in an amount of 10 to 100 parts by weight, and
antimony trioxide in an amount of 2 to 50 parts by weight.
